(19) United States
(12) Patent Application Publication
(10) Pub. No.: US 2025/0045058 A1
(43) Pub. Date: Feb. 6, 2025

(54) HIGH-VOLUME MANUFACTURING TRENDS USING I/O HEALTH CHECK

(71) Applicant: DELL PRODUCTS L.P., Round Rock, TX (US)

(72) Inventors: Douglas S. Winterberg, York, SC (US); Vijender Kumar, Bangalore (IN); Bhyrav Mutnury, Austin, TX (US)

(21) Appl. No.: 18/460,260

(22) Filed: Sep. 1, 2023

(30) Foreign Application Priority Data
Aug. 2, 2023 (IN) 202311052041

(51) Int. Cl. G06F 9/4401

(52) U.S. Cl. CPC G06F 9/4401

(57) ABSTRACT

An information handling system includes a baseboard management controller (BMC), an I/O device, and a BIOS. The BIOS initializes a parameter of the I/O device with a particular value, and includes an I/O health check module. Each time the BIOS initializes the first parameter, the I/O health check module receives the particular value, determines whether or not the particular value is within a predetermined range of values, and provides the particular value to the BMC. The BMC logs the values from each time the BIOS initializes the parameter, determines a health status for the information handling system based upon the logged values, and provides an indication of the health status.

### FIELD OF THE DISCLOSURE

This disclosure generally relates to information handling systems, and more particularly relates to improving high-volume manufacturing (HVM) trends using I/O health check.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a baseboard management controller (BMC), an I/O device, and a BIOS. The BIOS may initialize a parameter of the I/O device with a particular value, and may include an I/O health check module. Each time the BIOS initializes the first parameter, the I/O health check module may receive the particular value, determine whether or not the particular value is within a predetermined range of values, and provide the particular value to the BMC. The BMC may log the values from each time the BIOS initializes the parameter, determine a health status for the information handling system based upon the logged values, and provide an indication of the health status.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a flowchart illustrating a method for improving HVM trends using I/O health check according to an embodiment of the current disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

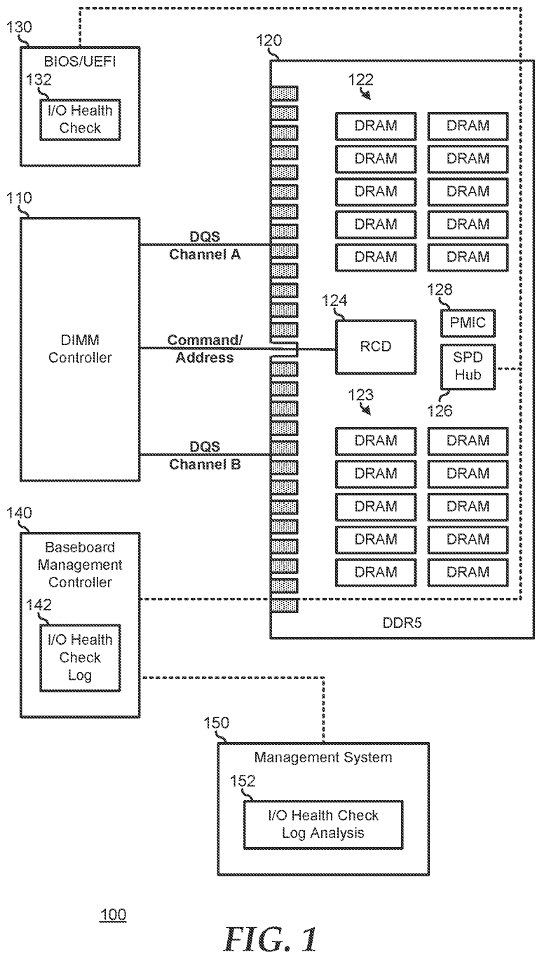

FIG. 1 illustrates an information handling system 100 including a dual in-line memory module (DIMM) controller 110, a fifth generation double data rate (DDR5) DIMM 120, a Basic Input/Output System (BIOS)/Universal Extensible Firmware Interface (UEFI) 130, and a baseboard management controller (BMC) 140. DIMM 120 includes a first channel (channel A) dynamic random access memory (DRAM) array 122, a second channel (Channel B) DRAM array 123, a registering control device (RCD) 124, a serial presence detect (SPD) hub 126, and a power management integrated circuit (PMIC) 128. DIMM controller 110 represents hardware that is typically included in a central processing unit (CPU) of information handling system 100 and operates to manage the data communication interactions with DIMM 120.

In particular, DIMM controller 110 includes a first data bus for conducting data transactions with DRAM array 122, a second data bus for conducting data transactions with DRAM array 123, and a command/address bus for conducting command/address transactions with RCD 124. As illustrated, information handling system 100 includes only one DIMM controller 110 that conducts memory transaction with a single DIMM 120. However, a typical information handling system may include one or more additional DIMM controllers as needed or desired, and a particular DIMM controller may operate to conduct memory transactions with one or more additional DIMM over the channel A and channel B data buses and the command/address bus, as needed or desired. The details of operation of memory channels in accordance with the DDR5 standard are known in the art and will not be further described herein, except as may be needed to illustrate the current embodiments.

BIOS/UEFI 130 operates during a system boot phase to initialize information handling system 100. In particular, BIOS/UEFI 130 is connected to SPD hub 126 and operates to execute memory reference code that reads information related to the configuration and capabilities of DIMM 120, and to set up the operating parameters of the DIMM and of DIMM controller 110 to ensure the proper operation of the DIMM controller and the DIMM to reliably conduct the memory transactions during a run time phase of operation of information handling system 100. The details of the communication between a BIOS/UEFI and a DIMM during a system boot phase, of memory reference code execution, of setting up the operating parameter of a DIMM controller and the connected DIMMs are known in the art and will not be further described herein, except as may be needed to illustrate the current embodiments.

BMC 140 is connected to SPD hub 126 and operates during a pre-boot phase of operation on information handling system 100 to monitor, manage, and maintain the operational state of DIMM 120. In particular, BMC 140 operates to provide management status information to the management system. The details of BMC operation in the monitoring, managing, and maintaining of DIMMs are known in the art and will not be further described herein, except as may be needed to illustrate the current embodiments.

BIOS/UEFI 130 includes an I/O health check module 132. I/O health check module 132 represents various code modules instantiated in BIOS/UEFI 130 that each operate to provide monitoring and health check operations for the various I/O types within information handling system 100 (for example PCIe, SATA, DDR5, etc.). In particular, I/O health check module 132 operates to collect the various operating parameters that are set up for the different I/O interfaces by BIOS/UEFI 130 during the system boot phase, and to evaluate the settings to make a pass/fail determination as to whether or not the particular I/O interface is set up to operate within predetermined operating parameters for that I/O interface. For example, in the context of DDR interfaces, I/O health check module 132 operates to monitor the memory initialization process as performed by the memory reference code during the system boot phase. The parameters that are monitored may include command/address bus write leveling, data bus read/write training (for example DQ-DQS leveling, Vref, EQ training, etc.), or other parameters, such as timing margins, read/write voltage margins, or the like.

When executed during the manufacturing of information handling system 100, I/O health check module 132 operates to ascribe pass/fail criteria to the initialization and set up parameters for DIMM 120. Then when information handling system 100 is deemed to have passed the criteria, the information handling system may be judged to be a sound system that is suitable for delivery to end users. On the other hand when information handling system 100 is deemed to have failed the criteria, the information handling system may be judged to be unsuitable for delivery, or in need of remedial action to resolve issues with the information handling system.

It has been understood by the inventors of the current disclosure that, as the speed of high-speed data communication interfaces, such as the DDR5 interface, increases, smaller variations in manufacturing tolerances are having outsized impact on the signal integrity of information handling systems. Here not only differences in design are indicated, but also differences between components of a common type. Examples of manufacturing tolerances may include variations in the DIMM itself, such as DIMM capacities and topologies, DRAM variations, raw card variations, and the like, variations in the PCB, such as trace topology variations, variations between PCB manufacturers, socket and connector variations, component variations, and the like.

A designer of information handling systems may typically design with the worst-case stack-up of all of the known variations in order to ensure that sound systems are manufactured. However such worst-case stack-up design may result in designs that are too conservative, leading to over-design of the information handling system. Further, gathering data on information handling systems during the manufacturing process is typically cumbersome and inaccurate, particularly when sample sizes (that is, production run sizes) are small. Moreover even when sufficient manufacturing data can be collected, such data is typically unable to provide predictions of imminent failures.

In a particular embodiment, data from I/O health check module 132 is utilized throughout the lifecycle of information handling system 100. For example, I/O health check module 132 may be routinely invoked, such as during any system boot phase experienced by information handling system 100, may be periodically invoked, such as once a week, once a month, or another period as needed or desired, or may be otherwise invoked during the lifecycle of the information handling system to gather the data after the manufacturing process for the information handling system. The I/O health status data from I/O health check module 132 is provided to BMC 140 for logging in an I/O health check log 142.

The data in I/O health check log 142 is utilized throughout the lifecycle of information handling system 100 to monitor for excursions from the previously experienced normal system behavior. The excursions may be determined based on a predetermined threshold for the various operating parameters, on a percentage or ratio of the previously experienced norm, or on another basis, as needed or desired. In a particular case, several thresholds, percentages, or ratios may be established, so as to provide a graded indication of the I/O health status of the monitored I/O interfaces, such as by providing an alert indication for minor excursions, a watch indication for moderate excursions, a warning indication for large excursions, and a failure indication for catastrophic excursions. Such indications are provided by BMC 140 to management system 150 to bring the status information to the attention of a system administrator. In this way, information handling system 100 is tracked to identify the likelihood of imminent failures, and the system administrator can take preventive measure to avoid system down time by replacing failing components, or the like.

In another embodiment, the I/O health status of multiple information handling systems similar to information handling system 100 is collected by management system 150 and is analyzed to detect trends in the I/O health status of the multiple information handling systems, to identify trends in manufacturing robustness, or the like. In particular, management system 150 includes an I/O health check log analysis module 152 that is configured to receive the I/O health status from the multiple information handling systems and to perform various statistical and regression analyses to identify the manufacturing trends. In this regard management system 150 operates to retrieve additional information from the information handling systems, such as the model type, the installed components, lot and date code information on critical components of the information handling systems, such as on processors, installed components, PCBs, or the like, operating conditions of the information handling systems, or other information that may correlate to the health of the information handling systems that may be utilized to provide meaningful feedback to the manufacturing process. For example the trend information may be deemed to be related to PCBs manufactured by a particular manufacturer, to CPU lot, to DIMM vendor or DRAM vendor, or the like. Here a manufacturer of information handling systems has a tool to direct manufacturing improvements, for example by holding a less reliable PCV manufacturer to a tighter quality standard, or the like.

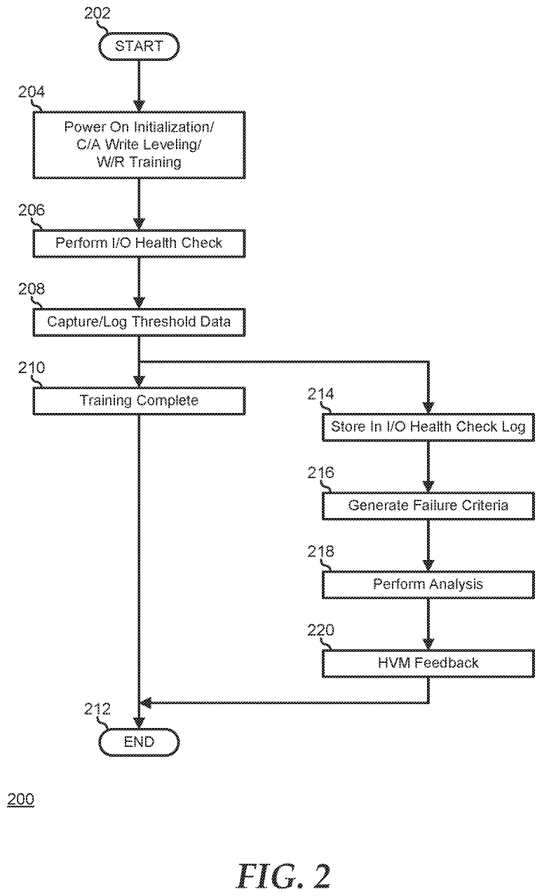

FIG. 2 illustrates a method 200 for improving HVM trends using I/O health check, starting at block 202. A power-on initialization phase of operation on an information handling system is initiated in block 204. The power-on initialization phase will include DDR command/address write leveling, read/write training, and other I/O interface initialization as needed or desired. An I/O health check module is invoked to monitor the set up parameters of the I/O interfaces of the information handling system in block 206, and the thresholds, settings, configurations of the I/O interfaces are captured and logged in block 208. The training of the high-speed data communication interfaces is completed in block 210, and the method ends in block 212.

After logging the thresholds, settings, and configurations of the I/O interfaces in block 208, the thresholds, settings, and configurations are logged in an I/O health check log in block 214, and a failure criteria for the information handling system is established in block 218. The failure criteria may be provided for the individual information handling system as needed or desired. Analyses of the I/O health check log information from multiple information handling systems is performed to determine the impacts to the HVM of the information handling systems in block 218. Feedback is provided to the manufacture of future information handling systems based on the analyses in block 220 and the method ends in block 212.

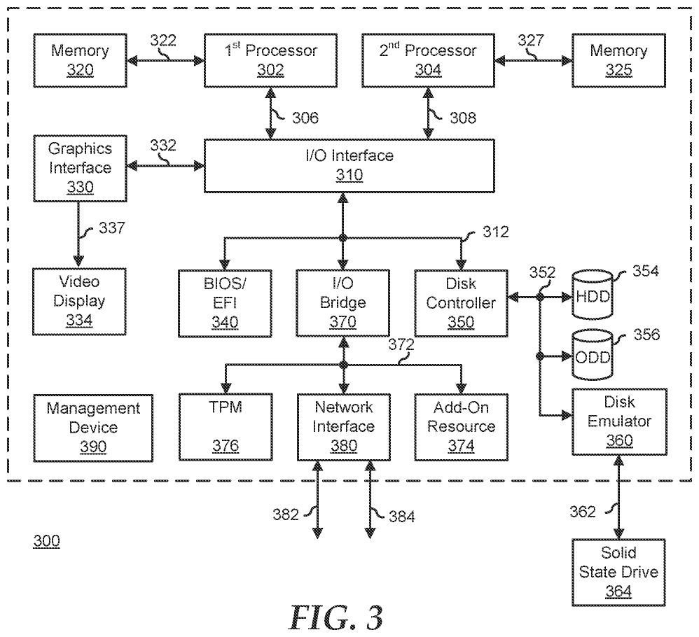

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply. Processors 302 and 304, I/O interface 310, memory 320 and 325, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 337 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 2394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising;
a baseboard management controller (BMC);
a first I/O device; and
a Basic Input/Output System (BIOS) configured to initialize a first parameter of the first I/O device with a particular first value, wherein the BIOS includes an I/O health check module configured, each time the BIOS initializes the first parameter, to receive the particular first value, to determine whether the particular first value is within a first predetermined range of first values, and to provide the particular first value to the BMC;
wherein the BMC is configured to log the first values from each time the BIOS initializes the first parameter, to determine a health status for the information handling system based upon the logged first values, and to provide an indication of the health status.

2. The information handling system of claim 1, wherein the first I/O device is a dual in-line memory module (DIMM).

3. The information handling system of claim 2, the DIMM is a fifth generation double data rate (DDR5) DIMM.

4. The information handling system of claim 3, wherein the parameter includes one of a command/address bus write leveling, a data bus read/write leveling, a timing margin, and a read/write voltage margin.

5. The information handling system of claim 1, wherein the first I/O device is a PCIe device.

6. The information handling system of claim 1, wherein the first I/O device is a SATA device.

7. The information handling system of claim 1, wherein:
the BIOS is further configured to initialize a second parameter of the first I/O device with a particular second value;
the I/O health check module is further configured, each time the BIOS initializes the second parameter, to receive the particular second value, to determine whether or not the particular second value is within a second predetermined range of second values, and to provide the particular second value to the BMC; and
the BMC is further configured to log the second values from each time the BIOS initializes the second parameter, wherein the health status is further based upon the logged second values.

8. The information handling system of claim 1, further comprising:
a second I/O device, wherein:
the BIOS is further configured to initialize a second parameter of the second I/O device with a particular second value;
the I/O health check module is further configured, each time the BIOS initializes the second parameter, to receive the particular second value, to determine whether or not the particular second value is within a second predetermined range of second values, and to provide the particular second value to the BMC; and
the BMC is further configured to log the second values from each time the BIOS initializes the second parameter, wherein the health status is further based upon the logged second values.

9. The information handling system of claim 8, wherein:
the first I/O device is a DIMM; and
the second I/O device is a Peripheral Component Interconnect-Express (PCIe) device.

10. The information handling system of claim 1, wherein the indication includes an alert indication when the parameter value exhibits an excursion from the predetermined range that has a first value, a watch indication when the parameter value exhibits the excursion that has a second value greater than the first value, a warning indication when the parameter value exhibits the excursion that has a third value greater than the fourth value, and a failure indication when the parameter value exhibits the excursion that has a fourth value greater than the third value.

11. A method comprising;
instantiating a Basic Input/Output System (BIOS) configured to initialize a first parameter of a first I/O device with a particular first value;
each time the BIOS initializes the first parameter:
receiving, by an I/O health check module of the BIOS, the particular first value;
determining whether the particular first value is within a first predetermined range of first values; and
providing the particular first value to a baseboard management controller (BMC);
logging, by the BMC, the first values from each time the BIOS initializes the first parameter;
determining a health status for the information handling system based upon the logged first values; and
providing an indication of the health status.

12. The method of claim 11, wherein the first I/O device is a DIMM.

13. The method of claim 12, wherein the DIMM is a fifth generation double data rate (DDR5) DIMM.

14. The method of claim 13, wherein the parameter includes one of a command/address bus write leveling, a data bus read/write leveling, a timing margin, and a read/write voltage margin.

15. The method of claim 11, wherein the first I/O device is a Peripheral Component Interconnect-Express device.

16. The method of claim 11, wherein the first I/O device is a Serial-ATA device.

17. The method of claim 11, wherein:
the BIOS is further configured to initialize a second parameter of the first I/O device with a particular second value;
each time the BIOS initializes the second parameter, the method further comprises:
receiving, by the I/O health check module, the particular second value;
determining whether or not the particular second value is within a second predetermined range of second values; and
providing the particular second value to the BMC; and
logging, by the BMC, the second values from each time the BIOS initializes the second parameter, wherein the health status is further based upon the logged second values.

18. The method of claim 11, wherein:
the BIOS is further configured to initialize a second parameter of a second I/O device with a particular second value;
each time the BIOS initializes the second parameter, the method further comprises:
receiving, by the I/O health check module, the particular second value;
determining whether or not the particular second value is within a second predetermined range of second values; and
providing the particular second value to the BMC; and
logging, by the BMC, the second values from each time the BIOS initializes the second parameter, wherein the health status is further based upon the logged second values.

19. The method of claim 8, wherein:
the first I/O device is a dual in-line memory module (DIMM); and
the second I/O device is a Peripheral Component Interconnect-Express (PCIe) device.

20. A manufacturing system, comprising;
a management system; and
a plurality of information handling systems, each information handling system including:
a baseboard management controller (BMC);
a first I/O device; and
a Basic Input/Output System (BIOS) configured to initialize a first parameter of the first I/O device with a particular first value, wherein the BIOS includes an I/O health check module configured, each time the BIOS initializes the first parameter, to receive the particular first value, to determine whether or not the particular first value is within a first predetermined range of first values, and to provide the particular first value to the BMC;
wherein the BMC is configured to log the first values from each time the BIOS initializes the first parameter, to determine a health status for the information handling system based upon the logged first values, and to provide an indication of the health status;
wherein the management system is configured to receive the indications from the BMCs and to determine a manufacturing trend for the information handling systems based upon the indications.
